(19) United States
(12) Patent Application Publication
(10) Pub. No.: US 2023/0284094 A1
(43) Pub. Date: Sep. 7, 2023

(54) Handover Management In A Hybrid Mobile Network

(71) Applicant: CHARTER COMMUNICATIONS OPERATING, LLC, St. Louis, MO (US)

(72) Inventors: Saran Khalid, Denver, CO (US); MohammedYusuf Shaikh, Denver, CO (US)

(73) Assignee: CHARTER COMMUNICATIONS OPERATING, LLC, St. Louis, MO (US)

(21) Appl. No.: 17/684,844

(22) Filed: Mar. 2, 2022

(51) Int. Cl. H04W 28/08; H04L 47/2475; H04W 36/32; H04W 28/02

(52) U.S. Cl. CPC H04W 28/0975; H04L 47/2475; H04W 36/32; H04W 28/0268; H04W 28/0992

(57) ABSTRACT

Various embodiments comprise systems, methods, architectures, mechanisms and apparatus managing UE handovers between MNO and MVNO networks by using pre-emptive signaling between the two networks so as to coordinate UE session migration between the two networks, such as for UE having dual SIM capability and a software agent functioning as a connection manager is configured to reduce handover delay by maintaining an active profile of active applications, such as via a snapshot module configured to keep track of active packet flows for each application by, illustratively, tracking such application packet flows at the packet level and maintaining a corresponding snapshot of current application packet flows.

### FIELD OF THE DISCLOSURE

The present disclosure generally relates to wireless communications systems and related networks, and more particularly to user equipment handover processing in a hybrid mobile virtual network operator (MVNO) and MNO environment.

### BACKGROUND

This section is intended to introduce the reader to various aspects of art, which may be related to various aspects of the present invention that are described and/or claimed below. This discussion is believed to be helpful in providing the reader with background information to facilitate a better understanding of the various aspects of the present invention. Accordingly, it should be understood that these statements are to be read in this light, and not as admissions of prior art.

Mobile network operators (MNOs) typically own and manage significant telecommunications infrastructure used to provide wireless services via cellular coverage for users of their cellular/mobile network services. MNOs have deployed universal mobile telecommunications system (UMTS) nodes and/or high-speed packet access (HSPA) nodes to provide coverage to the users of their network. These deployments have been augmented by the deployment of third generation partnership project (3GPP) long term evolution (LTE) coverage (e.g., 4G/LTE) to increase network performance, provide new services and so on. New and planned deployment of 5G New Radio (5G NR) and related technologies provide further improvements in network performance as well new and/or improved network services.

Mobile virtual network operators (MVNOs) may own little or none of the telecommunications infrastructure used to provide wireless services such as cellular/mobile network services. For example, Multiple-System Operators (MSOs) such as cable television providers may operate as a MVNO by leveraging MSO wireless infrastructure (such as deployed fixed location access points (APs) and the like) as well as telecommunications infrastructure of a partner MNO (such as ubiquitously deployed 4G/LTE or 5G network nodes) to offer more coverage area for cellular/mobile network service offerings for MSO customers/users. Given that there is a cost to the MVNO of using MNO infrastructure, the MVNO preference is to use the MNO infrastructure only when necessary such that frequent offloading of MVNO users from the MNO is desired (i.e., initiating UE handoffs from MNO to MVNO whenever possible).[EJW1]

For MNOs and MVNOs where both offer wireless services overlapping within a given area or footprint, a mobile user or subscriber is typically kept within the connectivity bounds of just one of the wireless service providers, which in combination may be considered to be providing Hybrid Mobile Network Operation (HMNO).

Whether at wireless services coverage area edges, or even within overlapping coverage areas, user equipment (UE) of subscribers or users may frequently transition between MNO and MVNO. Such frequent transitions or handovers may be disruptive to the MNO and/or MVNO, and may result in loss to UE of some data or unnecessarily repeated data. Specifically, such frequent handovers may induce network degradation is the form of delays, jitter and repetitive data. Further, sessions with UE may be interrupted, thereby requiring establishment of new sessions which will result in a delay as well as a loss of data or duplicate transmission to ensure that data has not been lost.

### SUMMARY

Various deficiencies in the prior art are addressed by systems, methods, and apparatus for managing UE handovers between MNO and MVNO networks by using pre-emptive signaling between the two networks so as to coordinate UE session migration between the two networks, such as for UE having dual SIM capability and a software agent functioning as a connection manager is configured to reduce handover delay by maintaining an active profile of active applications, such as via a snapshot module configured to keep track of active packet flows for each application by, illustratively, tracking such application packet flows at the packet level and maintaining a corresponding snapshot of current application packet flows.

In various embodiments, a connection manager within UE may compare current UE location to stored data indicative of MSO small cell coverage areas to identify when the UE is approaching a coverage edge such that a snapshot may be preemptively prepared should the UE traverse a coverage boundary between the two networks. [EJW2]

A method according to an embodiment may comprise: in response to a determination that a location of user equipment (UE) receiving network services from a network node of a first network is proximate a coverage area of a network node of a second network, capturing a snapshot of packet flows of UE applications receiving network services from the first network; and in response to a determination that the UE will begin receiving network services from the second network, using a captured snapshot of packet flows of UE applications to define a current state of the UE applications during a session setup between the UE and the second network.

Additional objects, advantages, and novel features of the invention will be set forth in part in the description which follows, and will become apparent to those skilled in the art upon examination of the following or may be learned by practice of the invention. The objects and advantages of the invention may be realized and attained by means of the instrumentalities and combinations particularly pointed out in the appended claims.

### BRIEF DESCRIPTION OF THE DRAWINGS

The accompanying drawings, which are incorporated in and constitute a part of this specification, illustrate embodiments of the present invention and, together with a general description of the invention given above, and the detailed description of the embodiments given below, serve to explain the principles of the present invention.

FIG. 1 depicts a simplified network services architecture suitable for use in various embodiments;

FIG. 2 depicts a flow diagram of a UE handover management method in accordance with the embodiments;

FIG. 3 graphically depicts a message flow in accordance with the embodiments; and

FIG. 4 graphically depicts an exemplary snapshot of UE application packet flows.

It should be understood that the appended drawings are not necessarily to scale, presenting a somewhat simplified representation of various features illustrative of the basic principles of the invention. The specific design features of the sequence of operations as disclosed herein, including, for example, specific dimensions, orientations, locations, and shapes of various illustrated components, will be determined in part by the particular intended application and use environment. Certain features of the illustrated embodiments have been enlarged or distorted relative to others to facilitate visualization and clear understanding. In particular, thin features may be thickened, for example, for clarity or illustration.

### DETAILED DESCRIPTION

The following description and drawings merely illustrate the principles of the invention. It will thus be appreciated that those skilled in the art will be able to devise various arrangements that, although not explicitly described or shown herein, embody the principles of the invention and are included within its scope. Furthermore, all examples recited herein are principally intended expressly to be only for pedagogical purposes to aid the reader in understanding the principles of the invention and the concepts contributed by the inventor(s) to furthering the art, and are to be construed as being without limitation to such specifically recited examples and conditions. Additionally, the term, “or,” as used herein, refers to a non-exclusive or, unless otherwise indicated (e.g., “or else” or “or in the alternative”). Also, the various embodiments described herein are not necessarily mutually exclusive, as some embodiments can be combined with one or more other embodiments to form new embodiments.

The numerous innovative teachings of the present application will be described with particular reference to the presently preferred exemplary embodiments. However, it should be understood that this class of embodiments provides only a few examples of the many advantageous uses of the innovative teachings herein. In general, statements made in the specification of the present application do not necessarily limit any of the various claimed inventions. Moreover, some statements may apply to some inventive features but not to others. Those skilled in the art and informed by the teachings herein will realize that the invention is also applicable to various other technical areas or embodiments.

The various embodiments enable management of UE handovers within the context of a HMNO or other multiple network use case such as by using pre-emptive signaling between the two networks so as to coordinate UE session migration between the two networks. Various embodiments provide such functions within the context of UE having dual SIM capability configured to support dual subscriptions (MNO and MVNO), and a connection manager configured to reduce handover delay by maintaining an active profile of active applications, such as via a snapshot module configured to keep track of active packet flows for each application by, illustratively, tracking such application packet flows at the packet level and maintaining a corresponding snapshot of current application packet flows.

Various embodiments contemplate that UE include a connection manager comprising a software agent active at UE and configured to perform various functions associated with capturing/using snapshot information, UE network connection changes, and so on. The connection manager or connection manager agent (CMA) at the UE may cooperate with a connection manager server (CMS) at a service provider management entity or core network, where the CMS is configured to interact with the CMA at each of a large number of UE so as to perform the various network offloading, migration, load balancing, and other functions which result in changes to connectivity of UE. In various embodiments, the connection manager within UE may compare current UE location to stored data indicative of MSO small cell coverage areas to identify when the UE is approaching a coverage edge (e.g., within a threshold distance of the coverage edge such as measured by location, signal strength, etc.) such that a snapshot may be preemptively prepared should the UE traverse a coverage boundary between the two networks.

To conserve UE battery, processing, and/or memory utilization, the snapshot module may be configured for operation in an active tracking mode only when the UE is at or approaching certain locations (e.g., within a threshold distance of the coverage edge such as measured by location, signal strength, etc.), such as at a MNO or MVNO coverage boundary (e.g., cell edge) where the UE may be about to move between the wireless coverage footprints of the MNO/MVNO networks.

Various embodiments provide a handoff proxy mechanism (implemented via, illustratively, a handoff proxy) configured to handoff UE between networks (e.g., such as between MVNO and MNO networks) while maintaining existing UE connectivity and sessions as defined by snapshot data provided by the UE. Quality of Experience (QoE) of the user of the UE is maintained by reducing the amount of time associated with the handoff process. This reduction in handoff time may be achieved by a seamless migration of some or all of the active UE application sessions from source to destination network (i.e., even if only some sessions are seamlessly migrated, the time necessary to reestablish these sessions is reduced such that the total time for reestablishing all sessions is also reduced).[EJW3]

In various embodiments, geo-fencing or predictive coverage may be used to assist in determining appropriate locations (e.g., within a threshold distance of the coverage edge such as measured by location, signal strength, etc.) for snapshot module operation so as to avoid unnecessarily impacting battery usage and the like. In some embodiments, a network management element may be used to store a database of all UEs where UE can be uniquely identified via its Globally Unique Temporary Identifier (GUTI), International Mobile Subscriber Identity (IMSA), or other identifier.

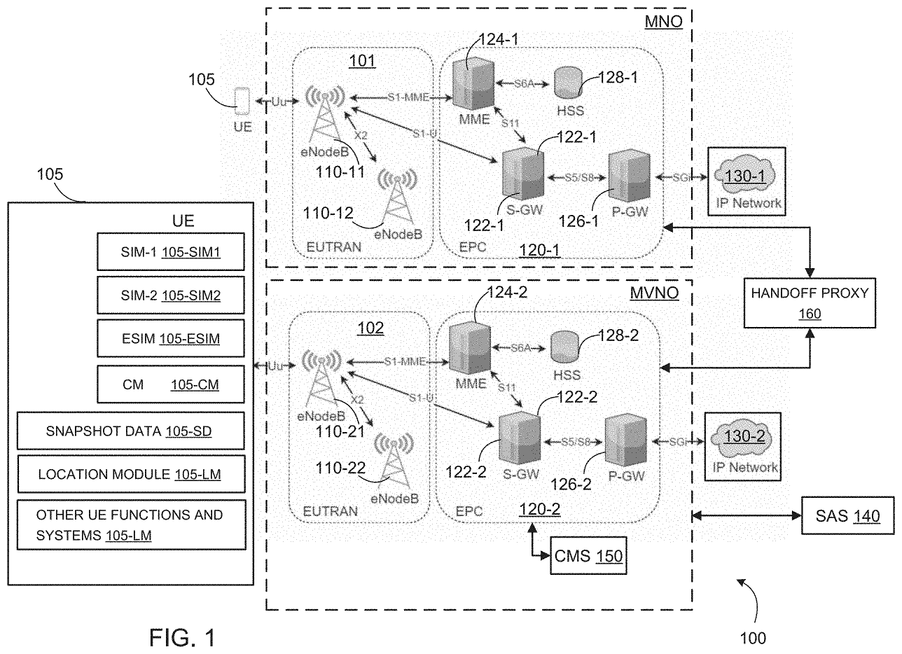

FIG. 1 depicts a simplified network services architecture suitable for use in various embodiments. Specifically, FIG. 1 depicts a first network (e.g., an MNO network) and a second network (e.g., an MVNO's own network), each network comprising respective deployed networking or telecommunications infrastructure configured to provide network services (e.g., voice, streaming media, data upload/download etc.) services to respective subscribers/users. It will be appreciated that while the illustrative first and second networks comprise respective MNO and MVNO networks, these networks may comprise any sort of networks wherein management of UE handovers therebetween benefit from the various embodiments. Further, each of the first and second networks may be formed as multiple networks associated with a common owner, such as an MNO or MVNO having deployed infrastructure using licensed spectrum and infrastructure using unlicensed spectrum, wherein the licensed spectrum infrastructure is used to augment services provided by the unlicensed spectrum infrastructure in a manner similar to that as described herein where MNO infrastructure is used to augment services provided by MVNO infrastructure.

The first network MNO is configured to provide network services to respective subscribers/users via user equipment (UE) 105 configured to communicate with MNO nodes (e.g., nodes 110-11, 110-12, and so on) of, illustratively, a E-UTRAN (LTE access network) connected to a core network, illustratively an evolved packet core (EPC) 120-1 which provides network services from/to external networks 130-1.

The second network MVNO is configured to provide network services to respective subscribers/users of a MVNO via user equipment (UE) 105 configured to communicate with MVNO nodes (e.g., nodes 110-21, 110-22, and so on) of, illustratively, a E-UTRAN (LTE access network) connected to a core network, illustratively an evolved packet core (EPC) 120-2 which provides network services from/to external networks 130-2.

In the various examples described herein, the second network MVNO is the preferred or primary network and the first network MNO is a backup or secondary network. The various embodiments operate to efficiently migrate UE from primary to secondary networks in an energy efficient manner that also reduces interruptions of network services delivery to the UE, with an additional goal of returning the UE to the primary network as soon as practicable.

As depicted in FIG. 1, at least portions of the deployed infrastructure and operation thereof associated with the first network MNO are substantially similar to corresponding portions of the second network MVNO. As such, the below description of the deployed infrastructure and operation thereof associated with the first network MNO is applicable to that of the second network MVNO. It is noted that in various embodiments, the deployed infrastructure and operation thereof associated with the first and second networks may be entirely different (e.g., a 4G/LTE core network 120, a 5G New Radio core network 120, differing access points or nodes 110, and so on). It is further noted that different types of deployed MNO and MVNO infrastructure may be used within the context of the various embodiments, such as via differing types of nodes 110 supported by 4G/LTE, 5G New Radio, and/or other types of core networks 120, differing types of wireless access points, and so on.

A handoff proxy (HP) 160 is depicted as communicating with each of the first 120-1 and second 120-2 EPCs 120 to facilitate UE handovers between the two networks. In various embodiments the HP 160 communicates with only one of the EPCs 120, illustratively the EPC 120 associated with a primary network having the smaller coverage footprint or otherwise more likely to be a source network of UE migrating toward a destination network, such as the second network MVNO. The HP 160 will be discussed in more detail below.

The HP 160 may be implemented via a gateway or server device having memory, storage, processing power, and the like. The memory for storing information pertaining to snapshots related to UEs and recent sessions, the storage for instructions for the processor to enable packet sniffing/processing operations, storing instructions for use by the processor to implement the various embodiments, long term data storage, and so on. The HP 160 may be implemented using a commercial server, using a cloud as a service, and/or other mechanisms as would be known to those skilled in the art and informed by the teachings provided herein. In various embodiments, the HP 160 is provided as a function within a 5G core architecture in which the handoff proxy (HP) function is managed using the various 5G core management entities, such as represented in the various 5G service-based architectures.

As depicted in FIG. 1, the first network MNO comprises nodes 110-1x comprising macrocells, small cells, microcells and the like such as eNodeBs (eNBs), cellular network base stations, 4G/5G repeaters, and similar types of provider equipment or logical radio nodes (e.g., gNBs) derived therefrom. The nodes 110-1x may include nodes that use licensed 3G/4G/LTE/5G spectrum, unlicensed spectrum such as citizens broadband radio service (CBRS) spectrum, or a combination of licensed and unlicensed spectrum. In the case of nodes 110-1x having Citizens Broadband Radio Service Device (CBSD) capability, allocations of CBRS spectrum are provided via a Spectrum Access System (SAS) (not shown).

Each of the nodes 110-1x provides network services to UE 105 via respective radio bearer (channels/resources) which are managed by various Radio Resource Management functions, such as Radio Bearer Control, Radio Admission Control, Connection Mobility Control, Scheduling of UEs in both uplink and downlink and so on. The Radio Resource Management functions are configured to provide appropriate Quality of Service (QoS) levels to each UE using one or more radio bearers, to maximize throughput at each node 110 while maintaining “fairness” to the UE attached thereto, to monitor various performance metrics, to provide data to the core network or network management entities and the like. The MNO nodes 110-1x communicate with a core network comprising an evolved packet core (EPC) 120-1, comprising, illustratively, a Serving Gateway (SGW) 122-1, a Mobility Management Entity (MME) 124-1, a Packet Data Network (PDN) Gateway (PGW) 126-1, a Home Subscriber Server (HSS) 128-1, other network elements (not shown) operative to provide the various functions necessary to enable UE authentication, network services, application services and the like as is known.

As depicted in FIG. 1, the second network MVNO comprises nodes 110-2x comprising macrocells, small cells, microcells and the like such as eNodeBs (eNBs), cellular network base stations, 4G/5G repeaters, and similar types of provider equipment or logical radio nodes (e.g., gNBs) derived therefrom. The nodes 110-2x may include nodes that use licensed 3G/4G/LTE/5G spectrum, unlicensed spectrum such as citizens broadband radio service (CBRS) spectrum, or a combination of licensed and unlicensed spectrum. In the case of nodes 110-2x having Citizens Broadband Radio Service Device (CBSD) capability, allocations of CBRS spectrum are provided via a Spectrum Access System (SAS) 140.

Each of the nodes 110-2x provides network services to UE 105 via respective radio bearer (channels/resources) which are managed by various Radio Resource Management functions, such as Radio Bearer Control, Radio Admission Control, Connection Mobility Control, Scheduling of UEs in both uplink and downlink and so on. The Radio Resource Management functions are configured to provide appropriate Quality of Service (QoS) levels to each UE using one or more radio bearers, to maximize throughput at each node 110 while maintaining “fairness” to the UE attached thereto, to monitor various performance metrics, to provide data to the core network or network management entities and the like. The MNO nodes 110-1x communicate with a core network comprising an evolved packet core (EPC) 120-2, comprising, illustratively, a Serving Gateway (SGW) 122-2, a Mobility Management Entity (MME) 124-2, a Packet Data Network (PDN) Gateway (PGW) 126-2, a Home Subscriber Server (HSS) 128-2, other network elements (not shown) operative to provide the various functions necessary to enable UE authentication, network services, application services and the like as is known.

The UE 105 may comprise any type of wireless device configured for use in accordance with the various embodiments, such as user terminals (e.g., mobile phones, laptops, tablets and the like), fixed wireless access devices (e.g., set top boxes, digital video recorders, stationary computing devices and the like), Internet of Things (IoT) devices (e.g., sensors, monitoring devices, alarm system devices and the like), and/or other wireless devices. The UE 105 may include UE that use licensed 3G/4G/LTE/5G spectrum, unlicensed spectrum such as Citizens Band Radio Spectrum (CBRS), or a combination of licensed and unlicensed spectrum.

The various embodiments contemplate the UE 105 are configured to communicate via each of the first 101-1 and second 101-2 networks. In the case each of these network utilizing mobile network (MN) radio access technology (RAT) such as 3G, 4G/LTE, and 5G, the UE 105 so configured comprise dual SIM UE (e.g., two SIM card capability, one SIM card and an eSIM, etc.).

As such, and as depicted in FIG. 1, UE 105 comprise a first SIM 105-SIM1 and at least one of a second SIM 105-SIM2 and an eSIM 105-ESIM, wherein a first SIM (or eSIM) is associated with a first subscription tied to the MNO network, and a second SIM (or eSIM) is associated with a second subscription tied to the MVNO small cell network. The UE 105 may comprise enhanced dual-subscription devices like Dual SIM Dual Standby (DSDS) UE. Further, a location module 105-LM may also be provided in the UE 105. Various other UE functions are also provided within the UE, though such functions are not discussed in detail herein.

Further, the UE 105 comprise a connection manager 105-CM configured to perform various functions such as will be described below, including gathering snapshot data (which may be stored in a snapshot database 105-SD), obtaining data relating to a quality of service or strength of signal of each of (i) a MVNO/MSO-provided CBRS service, and (ii) a MNO-provided cellular service to assist in the selection of one over the other based on the comparison (e.g., selection of a MVNO node 110-2x or MNO node 110-1x proximate the UE 105), communicating with various management entities such as a connection manager server at a home network (e.g., the MVNO network) so as to manage the timing and selection of service node attachment.

Generally speaking, the CM 105-CM and CMS 150 operate to assist/control a UE 105 in selecting an appropriate network (e.g., the MNO network when the MVNO network is not available, or the MVNO network when it becomes available) to transmit and receive user/application data. It will be noted that while an enhanced DSDS UE 105 with CM 105-CM enables internet data traffic to be transferred through either of the MNO and MVNO networks, due to the operation of the proxy 160 the end-user of the DSDS UE 105 (i.e., the user of UE 105) may only see connectivity to one network advertised in the device display, such as the MNO network. In other words there may be no indication regarding MVNO small cell network to the end-user, and the end-user may not necessarily be made aware whether MVNO small cell network being utilized at any given time. The CMS 150 and HP 160 may comprise separate management entities cooperating with each other to perform their various functions as described herein, or coordinating with each other to share in the performance of some or all of their various functions as described herein. The CMS 150 and HP 160 may be combined into a single entity, such as a single management entity, configured to perform substantially all of the various functions described herein with respect to each.

The UE connection manager 105-CM may comprise a computer program operative to execute on a digital processor apparatus, and configured to, when executed, obtain data relating to a quality of service or strength of signal of each of (i) the MSO-provided CBRS service, and (ii) the MNO-provided cellular service, and cause selection of one over the other based on the comparison. In one implementation, the connection manager entity (e.g., program) is disposed on a user mobile device (e.g., UE), and configured to autonomously obtain QoS data and perform a comparison of the networks based upon the obtained QoS data, such as at the then current location of the UE. In other embodiments, the UE connection manager 105-CM cooperates with the CMS 150 to provide thereto QoS data and/or other network or UE performance measurements such that the CMS 150 may perform network comparisons and other analysis (e.g., evaluate the CBRS and MNO cellular options at one or more locations or distances from a transmitter within a prescribed CBRS coverage area for one or more nodes 110-1x/110-2x).

Various elements or portions thereof depicted in FIG. 1 and having functions described herein are implemented at least in part as computing devices having communications capabilities, including for example the UE 105, nodes 110, SAS 140, CMS 150, proxy 160 and various portions of the core networks 120. These elements or portions thereof have computing devices of various types, though generally a processor element (e.g., a central processing unit (CPU) or other suitable processor(s)), a memory (e.g., random access memory (RAM), read only memory (ROM), and the like), various communications interfaces (e.g., more interfaces enabling communications via different networks/RATs), input/output interfaces (e.g., GUI delivery mechanism, user input reception mechanism, web portal interacting with remote workstations and so on) and the like.

As such, the various functions depicted and described herein may be implemented at the elements or portions thereof as hardware or a combination of software and hardware, such as by using a general purpose computer, one or more application specific integrated circuits (ASIC), or any other hardware equivalents or combinations thereof. In various embodiments, computer instructions associated with a function of an element or portion thereof are loaded into a respective memory and executed by a respective processor to implement the respective functions as discussed herein. Thus various functions, elements and/or modules described herein, or portions thereof, may be implemented as a computer program product wherein computer instructions, when processed by a computing device, adapt the operation of the computing device such that the methods or techniques described herein are invoked or otherwise provided. Instructions for invoking the inventive methods may be stored in tangible and non-transitory computer readable medium such as fixed or removable media or memory, or stored within a memory within a computing device operating according to the instructions.

For purposes of this discussion, it is assumed that the owners of the first network (e.g., an MNO) and the owners of the second network (e.g., an MVNO) have in place an agreement whereby UE 105 associated with subscribers/users of the MVNO network are able to receive subscribed-for services via the MNO network in areas where the infrastructure associated with the MVNO network (e.g., nodes 110-2x) do not provide sufficient network coverage or services to the UE 105, wherein such coverage/services is instead provided to the UE 105 via infrastructure associated with the MNO network (e.g., nodes 110-1x). In this case, the UE 105 attached to a MVNO node 110-1x is handed over to a MNO node 110-1x. Ideally, such a handover would be facilitated by the respective MMES 124-1/124-2, however this level of cooperation is typically unavailable.

Various embodiments facilitate handover of UE 105 between the two networks (e.g., MNO to MVNO or some other network, MVNO to MNO or some other network, some other network to MNO or MVNO, etc.) by using pre-emptive signaling between the two networks so as to coordinate UE session migration between the two networks. Various embodiments provide such functions within the context of UE having dual SIM capability (hard or eSIM) configured to support dual subscriptions (e.g., MNO and MVNO), and a connection manager configured to reduce handover delay by maintaining an active profile of active applications, such as via snapshots configured to keep track of active packet flows for each application by, illustratively, tracking such application packet flows at the packet level and maintaining a corresponding snapshot of current application packet flows. In various embodiments, a connection manager within UE may compare current UE location to stored data indicative of MSO small cell coverage areas to identify when the UE is approaching a coverage edge such that a snapshot may be preemptively prepared should the UE traverse a coverage boundary between the two networks

A snapshot for the UE may comprise control information as well as information pertaining to each application of interest (i.e., each application where rapid handover without application disruption is desired).

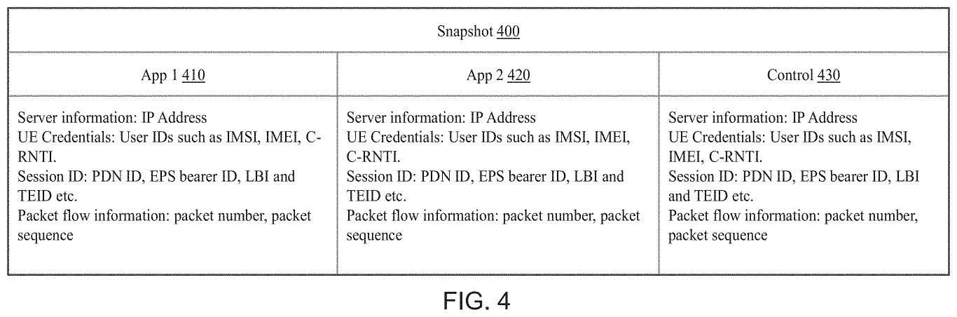

FIG. 4 graphically depicts an exemplary snapshot of UE application packet flows. Specifically, a snapshot 400 may include some or all of the following information for each application (e.g., 410-430) of interest: Server information such as IP Address and the like associated with a source or destination of an application packet flow; UE Credentials such as User IDs (e.g., IMSI, IMEI, C-RNTI, etc.) associated with an application packet flow or session supporting such a packet flow; Session ID such as PDN ID, EPS bearer ID, LBI, TEID, and the like associated with a packet flow or a session supporting such a packet flow; and Packet flow information such as packet number, packet sequence, stream type, stream identification, and the like.

Generally speaking, each snapshot of a an application, application packet flow, control session, voice instance/session, streaming media instance/session, and/or other network service comprises substantially all of the information necessary to define a breakpoint pause point associated with the delivery of that network service to/from the UE such that the network service may be momentarily paused while UE connectivity is migrated from a currently connected access point or node to a new access point or node, whereupon each snapshot will then be used to restart its respective network session, preferably in a substantially seamless manner. As such, snapshots associated with different network services may comprise more or less information.

Further, non-critical network services or network services that can be reinitialized in a standard manner without impacting use experience (e.g., email delivery, background updates to application, push notifications, and the like) may be selected to not be processed using the snapshot mechanism.

To conserve UE battery, processing, and/or memory utilization, the CM is configured to capture snapshots only when operating in an active tracking mode, such as triggered by the UE being located proximate certain locations, such as at a MNO or MVNO coverage boundary (e.g., cell edge) where the UE may be about to move between the wireless coverage footprints of the MNO/MVNO networks (e.g., within a threshold distance of a coverage footprint edge such as measured by location, signal strength, etc.).

In various embodiments, geo-fencing or predictive coverage may be used to assist in determining appropriate locations for snapshot module operation so as to avoid unnecessarily impacting battery usage and the like. In some embodiments, a network management element may be used to store a database of all UEs where UE can be uniquely identified via a Globally Unique Temporary Identifier (GUTI), International Mobile Subscriber Identity (IMSA), or other identifier.

Generally speaking, each of the networks 101 contain a database with all UEs 105 wherein each UE 105 may be uniquely identified via a respective identifier, such as a International Mobile Subscriber Identity (IMSI), Globally Unique Temporary Identifier (GUTI), or some other identifier. In the present embodiment, the GUTI is described within the context of the various figures.

In various embodiments, rather than handing off UE from a primary network to a secondary network, the HP 160 masks the use of the secondary network by the UE by providing some or all of the various applications/services to the UE using the second network while interacting with the UE as if such applications/services are being provided via the first network.

Generally speaking, various embodiments provide a method/mechanism in which, in response to a determination that a location of user equipment (UE) receiving network services from a network node of a first network is proximate a coverage area of a network node of a second network, capturing a snapshot of packet flows of UE applications receiving network services from the first network; and in response to a determination that the UE will begin receiving network services from the second network, using a captured snapshot of packet flows of UE applications to define a current state of the UE applications during a session setup between the UE and the second network.

As an example, consider a UE associated with both a MVNO and an MNO that moving along a street away from an MVNO node and toward an MNO node outside of the MVNO coverage rage. Since the MVNO network is tracking the UE, it can pre-emptively enable the UE's connection manager to start active profile tracking since the UE is likely to lose Charter's network coverage any moment. The UE's connection manager is activated and takes a snapshot of the application's packet flow. This snapshot will later be used to resume the same sessions on the server side instead of initiating new ones. This resumption of sessions towards servers etc. will save time and avoid delays. This snapshot is forwarded to MVNO network. From MVNO's perspective, this snapshot is unwrapped and used to resume the session(s) that were open on the native network. Specifically, the MVNO network will use previously established GUTI and use the credentials received in the snapshot to resume the session, and the application service provider servers (e.g., streaming media servers or data sources somewhere on the web) will not know the difference and will assume it's the same.

The MVNO masquerades as, and continues the session on behalf of, the native network while transferring the UE to its own network. It will also replace some fields that are needed to carry out communication at its own network. Hand off back into charter's network will go along similar lines. The connection manager will take a snapshot of the applications but the moment will be decided when the native network has been detected, communication established and It will be moments before the connection manager decided to make a switch to the native network. The native network will let the UE to record a snapshot of the application's active profile. This profile may be used to resume session(s). This type of implementation doesn't require additional hardware and requires an agreement between the MVNO and MNO.

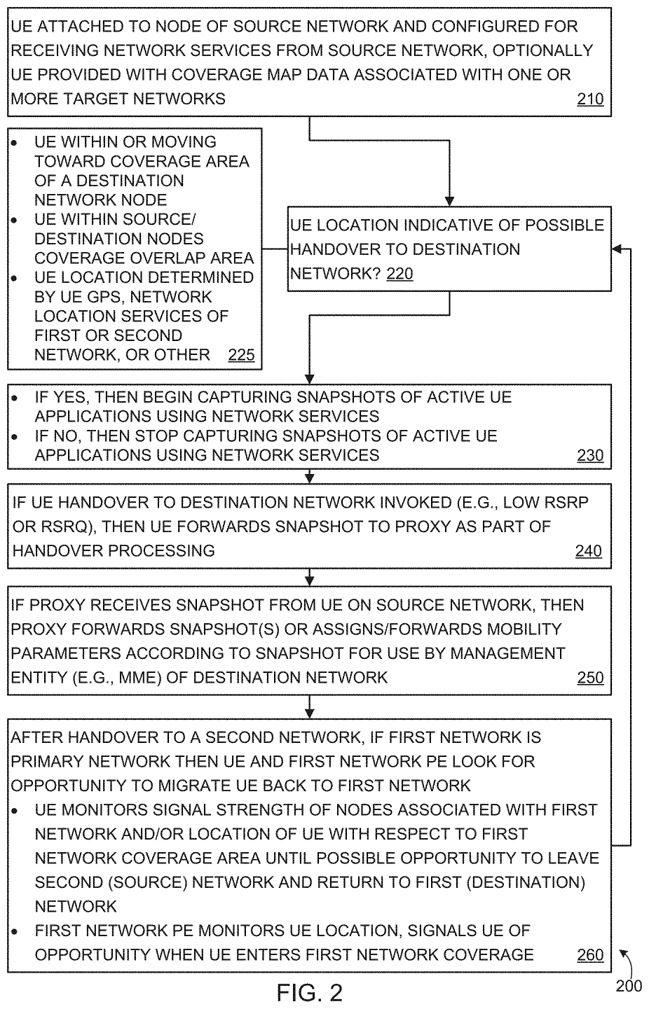

FIG. 2 depicts a flow diagram of a UE handover management method in accordance with the embodiments.

At step 210, the UE is attached to node of source network and configured for receiving network services from source network. Optionally, the UE is provided with coverage map data associated with one or more target networks. For example, US associated with the second network MVNO may be provided with coverage map data associated with the first network MNO, such as geo-boundaries, coverage footprints, or locations of nodes 110-1x (any information useful in determining whether the UE is near to or approaching a node 110-1x).

At step 220, a determination is made as to whether the UE location is indicative of possible handover to destination network. Referring to box 225, this determination may be made based upon the UE location being within or moving toward a coverage area of a destination network node, or being within a source node/destination node coverage overlap area (e.g., within a threshold distance of the coverage edge such as measured by location, signal strength, etc.). Further, this determination may be made by the UE itself, such as comparing UE location data (e.g., global positioning system or GPS data) to a map detailing relevant locations of source/destination network nodes, coverage areas, and the like associated with this determination.

At step 230, if the UE location is indicative of possible handover to destination network, then the UE connection manager is triggered to begin capturing snapshots of active UE applications using the existing network services. If the UE location is not indicative of possible handover to destination network (or indicative of moving away from such a location), then the UE connection manager may be triggered to stop capturing snapshots of active UE applications using the existing network services.

At step 240, if UE handover to a destination network is invoked (e.g., via a low signal QoS level), then the UE forwards a snapshot to the proxy as part of handover process. It is noted that the low signal QoS level may comprise, illustratively, a low Reference Signals Received Power (RSRP) level, a low Reference Signal Received Quality (RSRQ) level, or some other indication of poor or deteriorating radio performance. In various embodiments, if UE handover to a destination network is not invoked (e.g., the UE does not move out of the MVNO network even though near the MNO network), then the snapshot may be retained for a period of time by the CM in the UE such that, if the UE moves into the new area a little later than anticipated, the old snapshot may be used as part of the handover process. In various embodiments, only those portions of the snapshot relevant to currently active traffic flows are used.

For example, a Reference Signals Received Power (RSRP) of −90 dBm to −100 dBm is deemed to provide reliable data speeds, but this is marginal and drop-outs are possible. When this value gets close to −100, performance will drop drastically. As such, various embodiments contemplate that a handover to a new node is appropriate at a selected RSRP threshold level within the range of −90 to −100 dBm. Similarly, a Reference Signal Received Quality (RSRQ) of −15 dB to −20 dB is deemed to provide reliable but marginal data speeds, and drop-outs are possible. When this value gets close to −20, performance will drop drastically. As such, various embodiments contemplate that a handover to a new node is appropriate at a selected RSRQ threshold level within the range of −15 to −20 dB. The exemplary threshold level(s) or ranges described herein with respect to handover decisions may be selected in accordance with a desired uplink and/or downlink throughput associated with a handover (e.g., a 3 Mbps uplink channel and a 5 Mbps downlink channel). The desired throughput may comprise minimum throughput or QoS level(s), a nominal channel throughput or QoS level(s), a throughput or QoS level(s) guaranteed via a service level agreement (SLA), and so on.

At step 250, in response to receiving one or more snapshots from a UE, the proxy 160 (and/or CMS 150) assigns mobility parameters to the UE according to the snapshot(s) for use by the MME of the destination network (or just forwards the snapshots to the second destination network MME or other provide equipment (PE) thereat for processing).

At step 260, after handover to the second network, if the first network is the primary network then the UE and first network PE look for an opportunity to migrate the UE back to the first (primary) network, such as by the UE monitoring signal strength of nodes associated with first network, or UE location with respect to the first network coverage area (which may be stored at the UE) until there is an opportunity to leave second (source) network and return to first (destination) network, and/or the first network PE monitoring the location of UE and signaling UE when the monitored location is near or within the coverage area of the first network.

When the opportunity of step 260 arises, then the method proceeds to step 220 where the process of migrating the UE from the source network (second network) to the destination network (first network) is initiated.

In various embodiments, monitoring a location of UE migrated to the second network may comprises UE comparing a current location to a coverage area of the first network using a first network coverage map data stored at the UE or retrieved from first network provider equipment (PE). Monitoring a location of UE may also comprise determining, via radio QoS parameters, that a transmitter associated with the first network is nearby (i.e., that the location of the UE is proximate a coverage area of the first network) due to a determination that a wireless QoS parameter associated with the first network has returned to a selected range, such as discussed above. For example, the QoS parameter may comprise one or both of a Reference Signals Received Power (RSRP) of greater than −90 dBm, and a Reference Signal Received Quality (RSRQ) of greater less than −15 dB. Monitoring a location of UE may also comprise first network PE monitoring the location of the UE, such as via periodic communication with the UE (e.g., via the CM 1-05-CM) to retrieve location information therefrom.

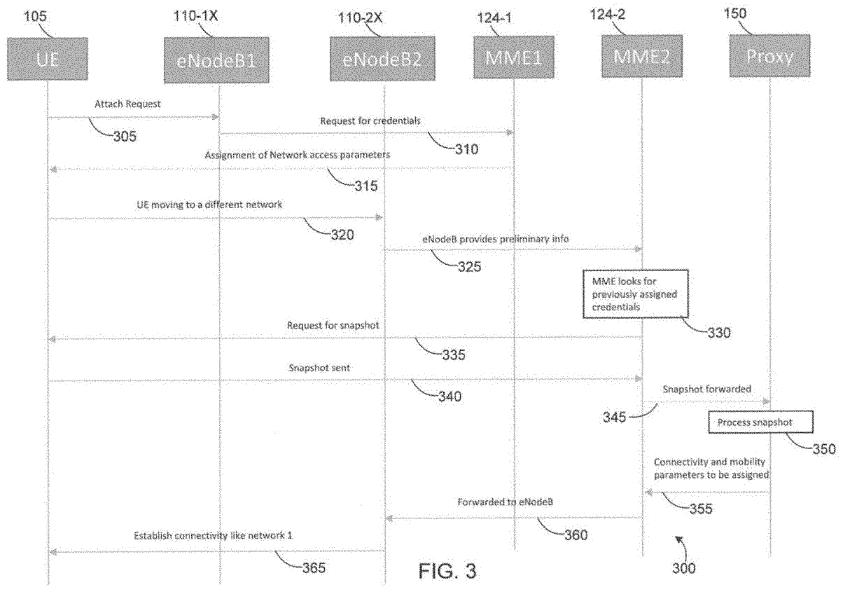

FIG. 3 graphically depicts a message flow in accordance with the embodiments. Specifically, the message flow 300 depicted in FIG. 3 comprises a message flow associated with a UE 105 connected to the first network 101-2 (source network) via a network node 110-1x managed by the MME of the first network 124-1 being handed over to the second network 101-2 (destination network) at a second network node 110-2x managed by the MME of the second network 124-2. The message flow 300 contemplates UE 105 taking (or having previously taken) a snapshot as discussed above, wherein that snapshot is processed by a proxy 160 to facilitate the handover, as discussed herein and above.

At step 305, the UE 105 transmits an attach request to a network node 110-1x of the first network 101-1 (eNodeB1), which in turn transmits at step 310 a request for credentials to the first MME 124-1. The first MME 124-1 determines the appropriate network access parameters and, at step 315, transmits these to the UE 105.

At step 320 it is determined that the UE is moving toward a different network, or proximate that network, such that a handover to the different network is invoked; namely, a node 110-2X associated with the second network 101-2 which responsively provides at step 325 preliminary information about the handover to the second network MME 124-2. The determination of the location of the UE with respect to the different network may be made by location services associated with the first network (e.g., location services that track the location of the UE and send an alert to the UE (connection manager) when its about to move out of the footprint), or UE-based location information such as GPS information.

At step 330, the second network MME 324-2 looks for previously assigned credentials associated with the UE 105 (e.g., subscriber information, device information, and the like). Upon determining that the UE 105 is authorized to receive network services from the second network 101-2 (e.g., the second MME re-establishes connection with the UE via an already established GUTI), the second network MME 324-2 transmits a request for a snapshot to the UE 105. The requested snapshot is provided to the second network MME 324-2 at step 340 (e.g., the UE receives the message and the connection manager enables the profile snapshot), which forwards it to the proxy 160 at step 345. In various embodiments, the UE 105 may include the snapshot in data transmitted to the node 110-2X associated with the second network 101-2 when the decision to migrate to the second network is made, which may be processed/forwarded to the proxy 160. In various embodiments, at a core network level the receiving network will treat the UE as a coming back UE and not a brand new connection.

At step 150, the proxy 160 processes the snapshot by extracting therefrom any control information and application information so that appropriate (efficient handover) connectivity and mobility parameters may be determined for assignment to the UE 105, which parameters are then transmitted at step 355 to the second network MME 324-2, and forwarded therefrom at step 360 to the relevant node 110-2X associated with the second network 101-2, which at step 365 establishes connectivity with the UE 105 in a manner similar to that previously experienced by the UE 105 with respect to the pre-handover operation with the first network 101-1, in conformance with the snapshot. That is, the destination network uses the credentials to re-establish the same sessions for the UE. but this time through the second network and until the session(s) expire or terminate. In various embodiments, the previously used credentials (i.e., the credentials of the UE when it was last on the network it is being connected to) may be used to avoid recreation of new ones and hence saving time and resources.

The above-described methods 200/300 contemplate that the proxy will assign the same parameters to the UE and take over the communication from the source network/carrier (i.e., that where the UE is being transferred from). In this manner, most way most of the messaging normally associated with a handover is avoided, and there is no need to establish connectivity from scratch. In various embodiments, the destination network is represented to the UE in the same manner as the source or native network associated with the UE.

That is, the destination network may masquerade as the source network and continue the session(s) on behalf of the source network while transferring the UE to its own network. It will also replace some fields that are needed to carry out communication within the destination network.

Migrating the UE back to the source (native) network is similar to the above-described process of migrating the UE form the source to the destination network. The connection manager will take a snapshot (or many snapshots) of the applications, the moment will be decided when the native network has been detected, communication established and then a short amount of time for processing before the connection manager decides to make a switch to the native network. The native network will let the UE record a snapshot of the application's active profile. This profile will be used to resume session(s). Advantageously, the various embodiments may be implemented with little or no additional hardware. In various embodiments, the assigned source network credentials are maintained for the UE such that migration back to the source network may be made more quickly using some or all of the retained source network credentials. Similarly, in various embodiments the assigned secondary network credentials are maintained for the UE such that migration back to the secondary network may be made more quickly using some or all of the retained secondary network credentials.

Various modifications may be made to the systems, methods, apparatus, mechanisms, techniques and portions thereof described herein with respect to the various figures, such modifications being contemplated as being within the scope of the invention. For example, while a specific order of steps or arrangement of functional elements is presented in the various embodiments described herein, various other orders/arrangements of steps or functional elements may be utilized within the context of the various embodiments. Further, while modifications to embodiments may be discussed individually, various embodiments may use multiple modifications contemporaneously or in sequence, compound modifications and the like. It will be appreciated that the term “or” as used herein refers to a non-exclusive “or,” unless otherwise indicated (e.g., use of “or else” or “or in the alternative”).

Although various embodiments which incorporate the teachings of the present invention have been shown and described in detail herein, those skilled in the art can readily devise many other varied embodiments that still incorporate these teachings. Thus, while the foregoing is directed to various embodiments of the present invention, other and further embodiments of the invention may be devised without departing from the basic scope thereof.

What is claimed is:

1. A method, comprising:
in response to a determination that a location of user equipment (UE) receiving network services from a network node of a first network is proximate a coverage area of a network node of a second network, capturing one or more snapshots of packet flows of UE applications receiving network services from the first network; and
in response to a determination that the UE will begin receiving network services from the second network, transmitting the one or more snapshots of packet flows of UE applications toward a handover proxy, the snapshots being configured to enable a mobility management entity (MME) of the second network to assign mobility parameters to the UE during a session setup between the UE and the second network such that respective packet flows of UE applications may be rapidly restored.

2. The method of claim 1, wherein the determination that the UE will begin receiving network services from the second network comprises determining that a wireless Quality of Service (QoS) parameter is outside of a selected range.

3. The method of claim 2, wherein the wireless QoS parameter comprises a Reference Signals Received Power (RSRP) of less than −90 dBm.

4. The method of claim 2, wherein the wireless QoS parameter comprises a Reference Signal Received Quality (RSRQ) of less than −15 dB.

5. The method of claim 1, wherein the determination that a location of user equipment UE receiving network services from a network node of a first network is proximate a coverage area of a network node of a second network is made using second network coverage map data stored at the UE.

6. The method of claim 5, wherein second network coverage map data stored at the UE is provided to the UE via the first network.

7. The method of claim 6, wherein a determination that the UE is proximate a coverage area of a network node of a second network comprises a determination that a current location of the UE is within a threshold distance of a second network coverage area edge.

8. The method of claim 7, wherein captured snapshot data is transmitted by the UE toward a second network management entity in response to a snapshot request received therefrom.

9. The method of claim 1, wherein each captured snapshot of a packet flow of a UE application includes a server address, a user identification, and a session identification.

10. The method of claim 1, wherein the UE location is determined by the UE.

11. The method of claim 1, wherein the UE location is determined by a network node of the second network determining that a signal strength associated with the UE exceeds a threshold level.

12. The method of claim 2, wherein the selected range is determined in accordance with a desired throughput of at least one of an uplink channel and a downlink channel.

13. The method of claim 1, further comprising monitoring a location of UE migrated to the second network and, in response to the UE being proximate a coverage area of the first network, initiating a migration of the UE back to the first network.

14. The method of claim 13, wherein monitoring a location of UE migrated to the second network comprises a UE comparing a current location to a coverage area of the first network using a first network coverage map data stored at the UE.

15. The method of claim 13, wherein monitoring a location of UE migrated to the second network comprises determining that a wireless QoS parameter associated with the first network has returned to a selected range.

16. The method of claim 15, wherein the wireless QoS parameter comprises at least one of a Reference Signals Received Power (RSRP) of greater than −90 dBm, and a Reference Signal Received Quality (RSRQ) of greater less than −15 dB.

17. The method of claim 13, wherein monitoring a location of UE migrated to the second network comprises first network provider equipment (PE) monitoring the location of the UE via periodic communication with the UE to retrieve location information therefrom.

18. Computer implemented provider equipment (PE) for managing user equipment (UE) connection to nodes of a first network and a second network, the PE comprising compute and memory resources configured for:
in response to receiving from user equipment (UE) one or more snapshots of respective packet flows of UE applications receiving network services from the first network and defining thereby a current state of the respective UE applications, forwarding the received snapshots toward PE of the second network, the snapshots being configured to enable a mobility management entity (MME) of the second network to assign mobility parameters to the UE during a session setup between the UE and the second network such that respective packet flows of UE applications may be rapidly restored.

19. User equipment (UE) configured to communicate with provider equipment (PE) of each of a first and second network and comprising compute and memory resources configured for implementing a connection manager (CM), the CM configured to perform a method, comprising:
in response to a determination that a location of the UE receiving network services from a network node of a first network is proximate a coverage area of a network node of a second network, capturing one or more snapshots of packet flows of UE applications receiving network services from the first network to define thereby a current state of the respective UE applications; and
in response to a determination that the UE will begin receiving network services from the second network, transmitting the captured one or more snapshots of packet flows of UE applications toward a handover proxy, the snapshots being configured to enable a mobility management entity (MME) of the second network to assign mobility parameters to the UE during a session setup between the UE and the second network such that respective packet flows of UE applications may be rapidly restored.

20. The UE of claim 19, wherein the determination that the UE will begin receiving network services from the second network comprises determining that a wireless Quality of Service (QoS) parameter is below a threshold level.

21. The UE of claim 20, wherein degradation of the wireless QoS parameter comprises at least one of a Reference Signals Received Power (RSRP) of less than −90 dBm, and a Reference Signal Received Quality (RSRQ) of less than −15 dB.
